(19) United States
(12) Patent Application Publication
(10) Pub. No.: US 2014/0062719 A1
(43) Pub. Date: Mar. 6, 2014

(54) USING SMART METERS AS RELIABLE CROWD-SOURCING AGENTS

(71) Applicant: Douglas Neal ROWITCH, Honolulu, HI (US)

(72) Inventor: Douglas Neal ROWITCH, Honolulu, HI (US)

(73) Assignee: QUALCOMM Incorporated, San Diego, CA (US)

(21) Appl. No.: 13/598,439

(22) Filed: Aug. 29, 2012

(51) Int. Cl. G08C 15/06

(52) U.S. Cl. 340/870.02

(57) ABSTRACT

Methods, systems, computer-readable media, and apparatuses for using a smart meter as a reliable crowd-sourcing agent are presented. In some embodiments, a smart meter installed at a location may observe one or more wireless signals at the location. Subsequently, the smart meter may provide, to at least one signal almanac server, information that identifies the location and describes one or more detected properties of the one or more observed wireless signals. In at least one arrangement, the information provided to the at least one signal almanac server may be configured to be used by the at least one signal almanac server in providing position assistance information to one or more mobile devices located in a vicinity of the location.

### BACKGROUND

Aspects of the disclosure relate to computing technologies, including computer software and computer hardware. In particular, various aspects of the disclosure relate to using a smart meter as a reliable crowd-sourcing agent.

Personal computing devices, such as mobile phones, tablet computers, laptop computers, and desktop computers, are becoming increasingly popular. Many people now frequently operate one or more of these computing devices in their home or office, among other places, on a daily basis.

In addition, a number of software applications, websites, and other functionalities that can be provided on a computing device are beginning to use position information to further enhance a user's experience when using such a device. For example, a device may access a particular website, such as a restaurant review website, and the website may use information about the device's current location in order to provide location-specific content, such as reviews of nearby restaurants, to the device. Other applications and websites may, for instance, use information about a device's current location to display relevant maps to a user, provide the user with information about local businesses, or inform the user of a local weather forecast.

In some instances, however, a device might not know its current location, and/or might lack certain specialized hardware, software, reference information, and/or other resources that could be used in determining the current location of the device.

One way of overcoming these issues is to have such a device observe wireless signals at its current location, and then use information about the observed signals along with previously stored “signal almanac” information, which specifies properties of the wireless signals that are observable in various locations, in order to determine the current location of the device. For the signal almanac information to be accurate and useful in determining position, however, information about observed signals at a great number of different locations may be needed, and the devices observing the signals (and thereby providing this “crowd-sourced” information about observable signals) may need to have accurate information about the locations at which the signals are observed.

In conventional systems that use crowd-sourced information about observable signals to determine position, end-user mobile devices, such as smart phones and tablet computers, may observe, store, and collect information about wireless signals, along with corresponding information about the locations at which particular signals can be observed. These devices then may periodically upload this information to one or more servers. The one or more servers may process and refine this crowd-sourced input information, and subsequently may store the information in one or more databases, which can then be used in assisting other mobile devices with position determination. To aggregate a useful amount of crowd-sourced information about observable signals in conventional systems, however, input information from a great number of mobile devices at a large number of locations might be needed. Moreover, the accuracy of the positions at which these mobile devices observe the various signals can affect the quality of the signal almanac information maintained by the servers. As these mobile devices might not always have a reliable or otherwise accurate estimation of their own position when observing wireless signals, the quality of the signal almanac information maintained by the servers might be less than desired.

### BRIEF SUMMARY

Certain embodiments are described that relate to using smart meters as reliable crowd-sourcing agents.

At a typical house, building, or other premises, a number of utility meters may be used to measure the extent to which various resources are consumed at the premises. For example, one or more utility meters may measure the amount of electric power consumed at the premises, the amount of water consumed at the premises, the amount of gas consumed at the premises, and/or the like. Often, these utility meters are analog devices that include various types of analog metering components that are configured to measure consumption of a particular resource. Increasingly, however, utility companies are replacing traditional, analog metering devices with so-called “smart meters.”

Like their traditionally analog counterparts, smart meters may measure the usage of one or more services provided by a utility company. For example, a smart meter can measure the amount of electric power consumed at a particular premises, thus enabling the electric power utility company that provides power to the premises to bill the occupant(s) of the premises for the consumed power. Unlike analog utility meters, however, smart meters may include electronic circuitry, such as one or more wireless or wireline transceivers, that allow these smart meters to electronically report usage measurements back to their respective utility company, thus avoiding the need for a person to visit the premises and manually read the meter.

Notably, a smart meter may be deployed at a known location at a particular house, building, or other relatively fixed service address) in order to measure service usage at that location. According to one or more aspects of the disclosure, a smart meter may be used to observe wireless signals at the location where the smart meter is deployed. The smart meter then may report information about observed wireless signals at its deployment location to a signal almanac database, in which information about observed wireless signals at various locations may be compiled and stored (e.g., for future use in assisting mobile devices in determining their position based on the wireless signals that they can observe).

In some embodiments, a smart meter installed at a fixed location may observe one or more wireless signals at the fixed location. Subsequently, the smart meter may provide, to at least one signal almanac server, information that identifies the fixed location and describes one or more detected properties of the one or more observed wireless signals.

In one or more arrangements, the information provided to the at least one signal almanac server may be configured to be used by the at least one signal almanac server in providing position assistance information to one or more mobile devices located in a vicinity of the fixed location. For example, the signal almanac server may be configured to receive observed signal information from a mobile device, analyze this information by comparing the signals observed by the mobile device with stored information originally received from one or more smart meters (and possibly other sources) about observable signals in various locations, and determine an estimated position of the mobile device based on the analysis of the signals observed by the mobile device. In other examples, the signal almanac server may be configured to provide the stored information to a mobile device so as to allow the mobile device to analyze the observed signal information and determine an estimated position for itself.

In some arrangements, the smart meter may be configured to measure consumption of one or more resources. In at least one arrangement, at least one resource of the one or more resources may be electric power. For example, although a smart meter may be used in collecting information about observed wireless signals in some embodiments, such a smart meter may still continue to provide its traditional metering and reporting functions.

In one or more arrangements, the information that characterizes the fixed location and describes the one or more detected properties of the one or more observed wireless signals may include one or more received signal strength indication (RSSI) measurements corresponding to the one or more observed wireless signals, one or more time of arrival (TOA) measurements corresponding to the one or more observed wireless signals, one or more angle of arrival (AOA) measurements corresponding to the one or more observed wireless signals, and/or one or more round trip time (RTT) measurements corresponding to the one or more observed wireless signals. These various properties may, for instance, provide the criteria for comparing observed wireless signals with stored information about observable signals, and thereby may facilitate determining an estimated position based on information about signals observed by a particular device.

In some arrangements, the information that identifies the fixed location and describes the one or more detected properties of the one or more observed wireless signals may include at least one of a street address, a service account number, a device identifier, and geographic coordinates. This information, which describes the location and identity of the smart meter, may, for instance, enhance the reliability of observed signal information provided by a particular smart meter, as this information may allow the signal almanac server to have more accurate information about the signals that are observable at a particular, and precisely defined, location.

In at least one arrangement, the smart meter may be operated by a first entity that provides at least one resource to a premises located at the fixed location, and the at least one signal almanac server may be operated by a second entity that is different from the first entity. For example, in some instances, the smart meter may be operated by a utility company, such as an electric power company, while the signal almanac server may be operated by a telecommunications company, such as a wireless service provider. In other instances, both the smart meter and the signal almanac server may be operated by the same entity.

In some arrangements, prior to observing the one or more wireless signals, the smart meter may receive location information specifying the fixed location at which the smart meter is installed. For example, such information may be received when the smart meter is initially configured and deployed at a particular location. This may, for instance, enable the smart meter to subsequently provide accurate information about its locations and the signals observed at its location.

### BRIEF DESCRIPTION OF THE DR. WINGS

Aspects of the disclosure are illustrated by way of example. In the accompanying figures, like reference numbers indicate similar elements, and:

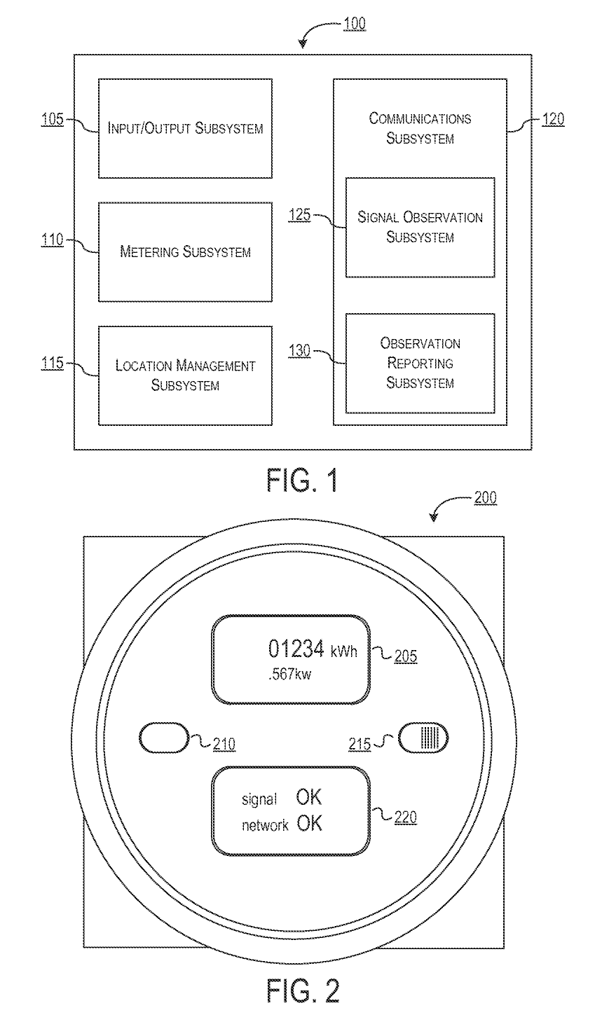

FIG. 1 illustrates a simplified diagram of a system that may incorporate one or more embodiments;

FIG. 2 illustrates an example of a smart meter according to some embodiments;

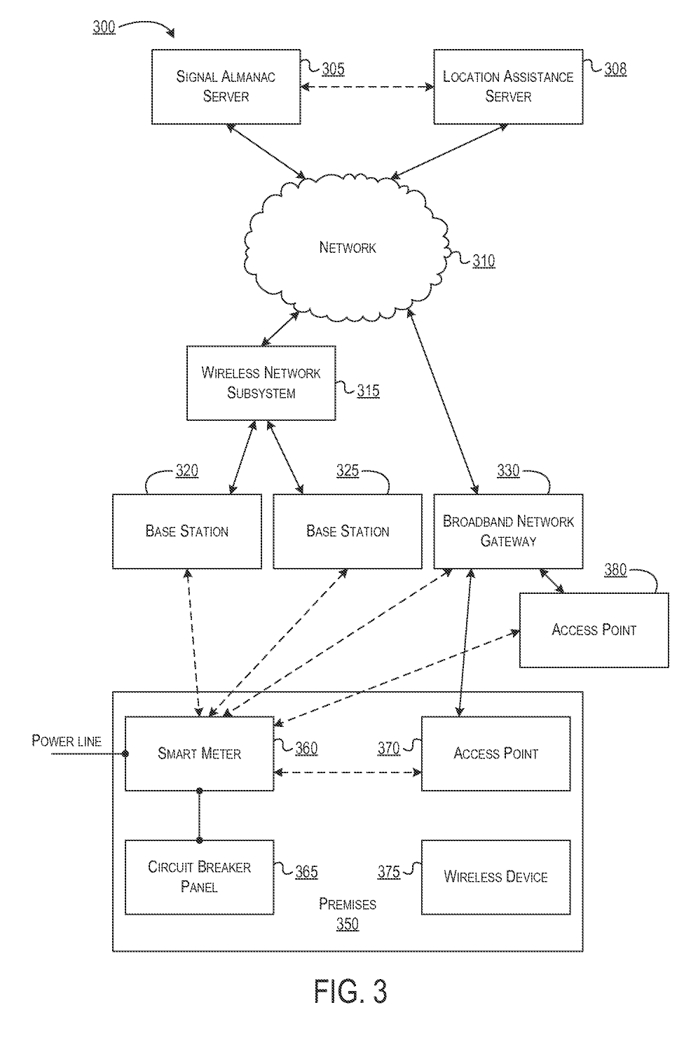

FIG. 3 illustrates an example operating environment of a smart meter according to some embodiments;

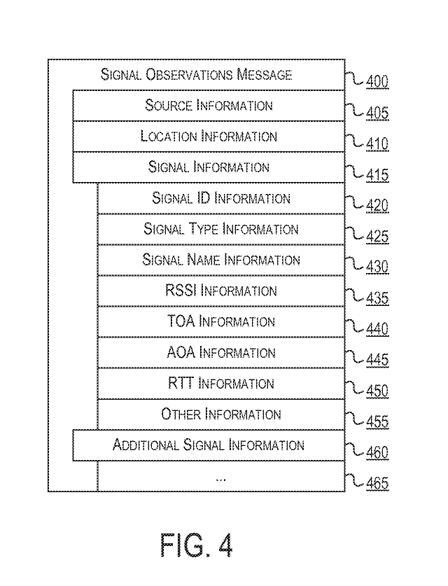

FIG. 4 illustrates an example of a signal observations message according to some embodiments;

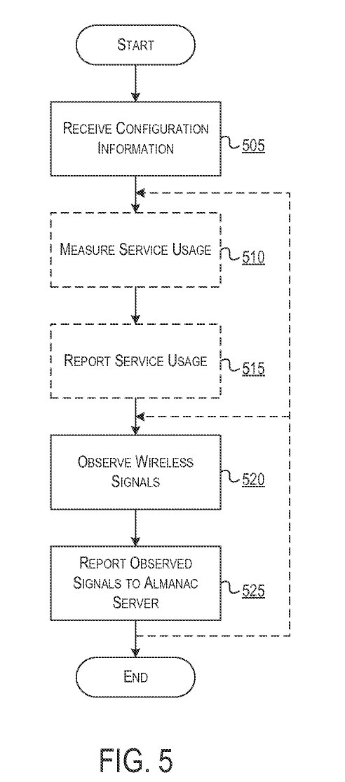

FIG. 5 illustrates an example method of providing information about observed wireless signals to a signal almanac server according to some embodiments;

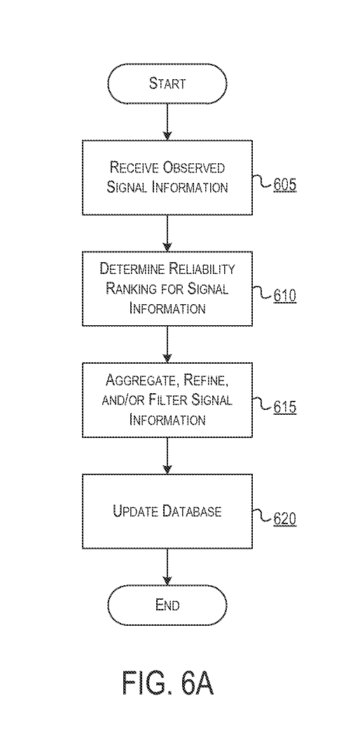

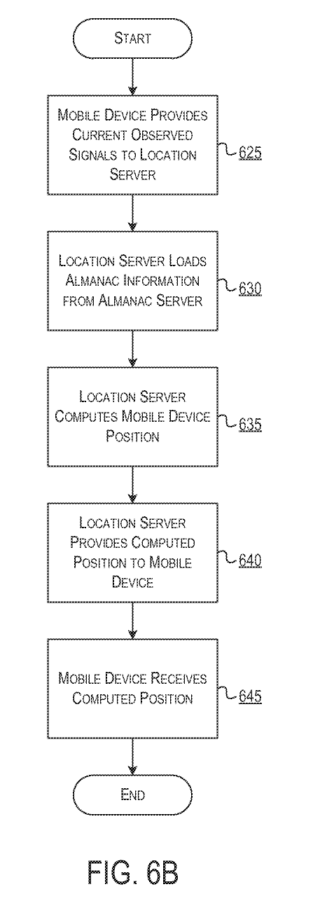

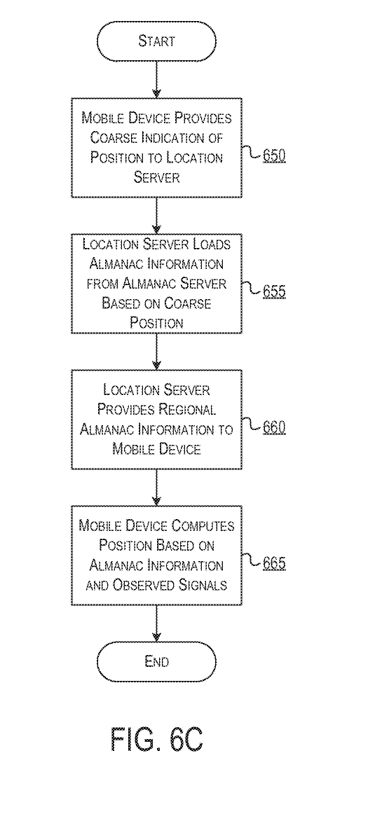

FIG. 6A illustrates an example method of receiving and maintaining information about observed wireless signals according to some embodiments;

FIG. 6B illustrates an example method of providing calculation assistance to a mobile device in an MS-Assisted mode of operation according to some embodiments;

FIG. 6C illustrates an example method of providing position assistance information to a mobile device in an MS-Based mode of operation according to some embodiments; and

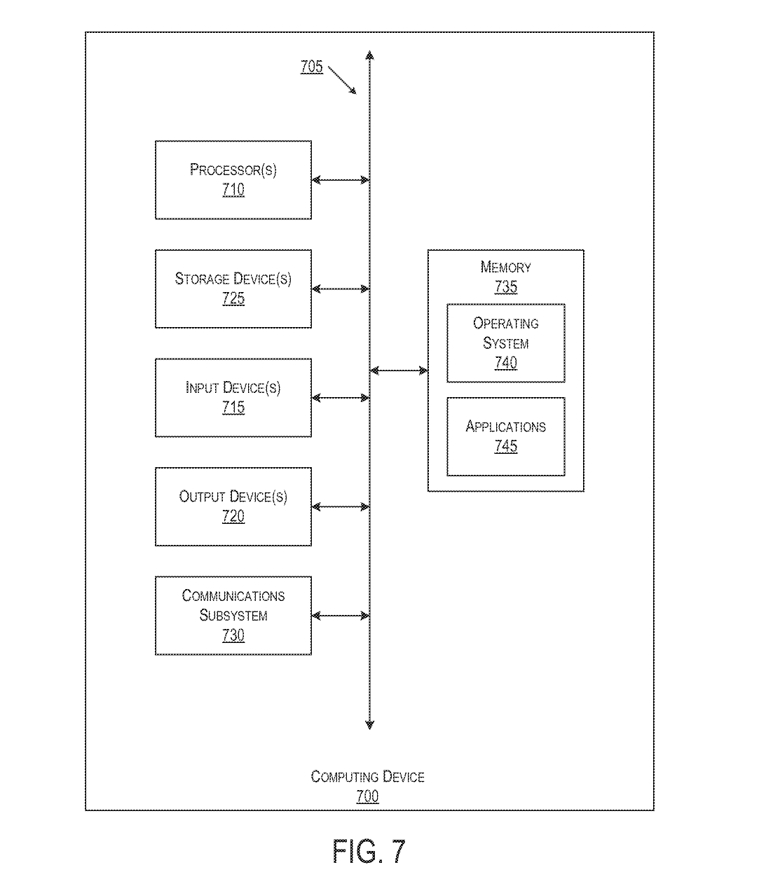

FIG. 7 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Certain embodiments are described that relate to using smart meters for observing wireless signals and reporting information about observed signals to a central location, such as a signal almanac server. This may enable other devices, such as mobile wireless devices, to determine their position based on the signals that they can observe, without using more complex location determination technologies, such as Global Positioning System (GPS) receiver hardware and software.

While some conventional systems may provide other types of signal-observation-based position determination, these systems often rely on expensive, inaccurate, and inconvenient techniques for gathering information about the wireless signals that are observable in particular locations, such as war driving or mobile-device-based crowd-sourcing. By using smart meters as reliable crowd-sourcing agents, however, in accordance with various aspects of the disclosure, information about observable wireless signals at various locations can be gathered and compiled more easily, accurately, and conveniently.

Various embodiments will now be discussed in greater detail with reference to the accompanying figures, beginning with FIG. 1.

FIG. 1 illustrates a simplified diagram of a system 100 that may incorporate one or more embodiments. In the embodiment illustrated in FIG. 1, system 100 includes multiple subsystems, including an input/output subsystem 105, a metering subsystem 110, a location management subsystem 115, and a communication subsystem 120, which may include a signal observation subsystem 125 and an observation reporting subsystem 130. One or more communication paths may be provided that enable the one or more subsystems to communicate with and exchange data with each other. In addition, the various subsystems illustrated in FIG. 1 may be implemented in software, hardware, or combinations thereof. In some embodiments, system 100 may be incorporated into a smart meter.

In various embodiments, system 100 may include other subsystems than those shown in FIG. 1. Additionally, the embodiment shown in FIG. 1 is only one example of a system that may incorporate some embodiments, and in other embodiments, system 100 may have more or fewer subsystems than those illustrated in FIG. 1, may combine two or more subsystems, or may have a different configuration or arrangement of subsystems.

In some embodiments, input/output subsystem 105 may provide one or more interfaces that enable input to be received from, and/or output to be provided to, a user of system 100. For instance, input/output subsystem 105 may include one or more input devices, such as one or more buttons or keys, a mouse, a cursor, a trackball, a microphone, one or more ports (e.g., a serial port), and/or other input devices. Additionally, input/output subsystem 105 may include one or more output devices, such as one or more display screens, one or more audio speakers, and/or other output devices.

In one or more arrangements, input/output subsystem 105 may allow for system 100 to be initially configured and programmed with its location information. For example, using one or more input devices and/or one or more output devices of input/output subsystem 105, a user, such as an employee of a utility company, may configure system 100 to store information about the location at which system 100 is deployed. Such information may be stored by location management subsystem 115, as discussed in greater detail below. In addition, the user may, for example, configure system 100 to measure the amount of consumption of one or more resources, and report these measurements back to a central server. As discussed below, these measurements may be obtained via metering subsystem 110.

In other arrangements, input/output subsystem 105 may allow for system 100 to be configured remotely (e.g., by a utility company). For example, a user, such as a technician or other employee of a utility company, may install a smart meter that incorporates and/or otherwise embodies one or more aspects of system 100 at a particular premises. Rather than having the technician enter the address of the premises into system 100, the address of the premises at which the smart meter is installed may be provided to system 100 by one or more remote users, who may, for instance, be located at a central office of the utility company. These users may, for instance, provide the address of the premises to the smart meter, based on a unique identifier corresponding to the smart meter. In these arrangements, the smart meter and/or system 100 may observe one or more wireless signals at its installation location. Subsequently, the smart meter and/or system 100 may report information describing these observations, along with its unique identifier, up to an almanac server in order to support position assistance functionalities, as discussed in greater detail below.

In some embodiments, metering subsystem 110 may enable system 100 to measure usage of one or more consumable utility services. For example, metering subsystem 110 may include one or more sensors, gauges, and/or other measurement devices that allow for various types of measurements. For instance, metering subsystem 110 may allow system 100 to measure an amount of electric power consumed (e.g., in kilowatt-hours) at a premises at which system 100 is located, an amount of water consumed at the premises at which system 100 is located, and/or an amount of gas consumed at the premises at which system 100 is located. In addition, metering subsystem 110 may store this usage information to facilitate reporting of the usage information to a central server, as discussed above.

In some embodiments, location management subsystem 115 may enable system 100 to determine and/or store information about a current location of system 100. For example, location management subsystem 115 may include one or more location determination components (e.g., a Global Positioning System (GPS) receiver) that enable system 100 to determine its current location. Additionally or alternatively, location management subsystem 115 may include one or more storage modules that enable system 100 to store information about its current location. Such information may, for instance, be determined using one or more location determination components included in location management subsystem 115. Additionally or alternatively, information related to the current location of system 100 may be determined during configuration of system 100.

For example, in some instances, a user may provide input specifying, during a configuration process, a particular location as being the current location of system 100, and location management subsystem 115 may store this location. In one or more arrangements, the location information stored by location management subsystem 115 may include various types of location information, including a street address corresponding to the location of system 100, geographic coordinates of the location of system 100, and/or error values associated with the location of system 100. Location management subsystem 115 also may store additional assistance information from which the location of system 100 may be determined, including an account number (e.g., associated with the service(s) being measured by metering subsystem 110) and/or a device identifier associated with system 100. For example, location management subsystem 115 may store a unique identifier corresponding to a smart meter that may incorporate and/or otherwise embody one or more aspects of system 100. Such a unique identifier may, for instance, be used to indirectly determine the installation location of the smart meter (e.g., via a remote entity that maintains location information for various smart meters in association with their respective unique identifiers).

In some embodiments, communications subsystem 120 may enable system 100 to communicate electronically with one or more other devices. Communications subsystem 120 may include one or more wired and/or wireless interfaces via which system 100 may send and/or receive information. Examples of wired interfaces that may be included in communications subsystem 120 include one or more Ethernet interfaces, one or more power-line communications interfaces, one or more serial port interfaces, and/or other wired communications interfaces. Examples of wireless interfaces that may be included in communications subsystem 120 include one or more cellular communications interfaces (e.g., one or more CDMA interfaces, WCDMA interfaces, GSM interfaces, etc.), one or more WLAN interfaces (e.g., one or more IEEE 802.11 interfaces and/or other wireless communications interfaces (e.g., Bluetooth, ZigBee, etc.).

in one or more arrangements, communications subsystem 120 may enable system 100 to observe wireless signals at the location at which system 100 is deployed, and report information about the observed signals to a central server, such as a signal almanac server. Along these lines, communications subsystem 120 may include a signal observation subsystem 125 and an observation reporting subsystem 130.

In some embodiments, signal observation subsystem 125 may cause system 100 and/or communications subsystem 120 to observe one or more wireless signals at the location at which system 100 is deployed. In observing wireless signals, signal observation subsystem 125 may, for instance, enable one or more wireless interfaces provided by communications subsystem 120, scan for and receive one or more wireless signals that are capable of being received at the location, and record and store information describing various properties of the received wireless signals, as well as any other information that may be desirable, such as the time and/or date at which the signals were received. Any and/or all of this information may subsequently be reported to a signal almanac server, for instance, by observation reporting subsystem 130.

In particular, in some embodiments, observation reporting subsystem 130 may cause system 100 and/or communications subsystem 120 to report information about the observed signals to a signal almanac server, which may access, store, and/or maintain a signal almanac database in which information about the wireless signals that are observable at various locations may be stored. In reporting information about the observed signals to a signal almanac server, observation reporting subsystem 130 may, for instance, establish a data connection with the signal almanac server and subsequently send one or more data messages to the signal almanac server. In some embodiments, one or more of these messages sent by observation reporting subsystem 130 may be a signal observations message, as discussed in greater detail below. Additionally or alternatively, observation reporting subsystem 130 may, in some instances, cause system 100 and/or communications subsystem 120 to indirectly report information about the observed signals to an almanac server (e.g., by reporting information about the observed signals to the almanac server via an entity or element controlled by a utility company that installed and/or otherwise deployed system 100).

FIG. 2 illustrates an example of a smart meter 200 according to some embodiments. In particular, as seen in FIG. 2, smart meter 200 may include one or more display screens, such as display screens 205 and 220, as well as one or more other components, such as one or more data ports (e.g., data port 210) and/or one or more switches or buttons (e.g., button 215).

In one or more arrangements, a smart meter, such as smart meter 200, may be installed on an exterior wall of a house, building, or other premises, or in a cabinet or closet, for instance, and the one or more components of the smart meter may allow for various types of information to be exchanged with the smart meter. For example, a user may take a reading from smart meter 200 by pressing button 215, which may turn on and/or illuminate display screens 205 and 220 of smart meter 200, and these display screens may be configured to provide various types of information. For instance, display screen 205 may display usage information measured by smart meter 200, and display screen 220 may display network and/or signal status information detected by smart meter 200. As another example, data port 210 may enable smart meter 200 to receive configuration information, which may include information specifying a current location of smart meter 200, during a configuration process, for instance.

FIG. 3 illustrates an example operating environment 300 of a smart meter 360 according to some embodiments. In particular, as seen in FIG. 3, operating environment 300 may include a signal almanac server 305 and a location assistance server 308. In one or more arrangements, signal almanac server 305 may be configured to access, store, and/or maintain a signal almanac database in which information about the wireless signals that are observable at various locations may be stored. For example, via network 310, signal almanac server 305 may receive information about wireless signals observed at particular locations (e.g., from smart meters, other sources, etc). Subsequently, signal almanac server 305 may aggregate, refine, and/or filter such information, and perform other functions associated with maintaining the signal almanac database, such as updating uncertainty values and/or reliability factors corresponding to various measurements.

In addition, location assistance server 308 may be configured to interact with one or more other devices in operating environment 300 via a network 310, so as to assist one or more wireless devices in determining their estimated position using information from the signal almanac database maintained by signal almanac server 305. For example, location assistance server 308 may be configured to calculate and return a position fix for a mobile device that provides signal observations to location assistance server 308 (e.g., in an “MS-Assisted” mode of operation). Additionally or alternatively, location assistance server 308 may be configured to select regional almanac information from the signal almanac database maintained by signal almanac server 305 based on a coarse position estimate provided by a mobile device, and subsequently provide such regional information to the mobile device in order to enable the mobile device to calculate a finer estimate of its own position (e.g., in an “MS-Based” mode of operation).

While signal almanac server 305 and location assistance server 308 are illustrated in FIG. 3 as being separate servers, in some embodiments, signal almanac server 305 and location assistance server 308 may be combined into a single server that performs any and/or all of the functionalities that each of signal almanac server 305 and location assistance server 308 may provide individually. For example, signal almanac server 305 may, in some embodiments, also provide any and/or all of the functionalities of location assistance server 308, instead of and/or in addition to the other functionalities provided by signal almanac server 305. In other embodiments, location assistance server 308 may also provide any and/or all of the functionalities of signal almanac server 305, instead of and/or in addition to the other functionalities provided by location assistance server 308. In still other embodiments, the functionalities of signal almanac server 305 and/or location assistance server 308 may be provided by any number of different servers and/or other computing devices, which may be located in the same place or in any number of different places.

In one or more arrangements, network 310 may provide connectivity to one or more other wired and/or wireless networks included in operating environment 300. For example, network 310 may be an Internet Protocol (IP) network, such as the Internet. In addition, network 310 may provide connectivity between signal almanac server 305, a wireless network subsystem 315, and a broadband network gateway 330.

In one or more arrangements, wireless network subsystem 315 may include one or more systems and components for providing wireless telephony and data networks, such as one or more gateways, switches, routers, controllers, registers, billing centers, service centers, mobile switching centers, base station controllers, and/or other systems and components. These systems and components may, for example, enable wireless network subsystem 315 to control one or more wireless base stations, such as base stations 320 and 325, which may transmit and receive radiofrequency signals to and/or from one or more mobile stations on the network(s) provided by wireless network subsystem 315.

In one or more arrangements, broadband network gateway 330 may include one or more systems and components for providing wired telephony and data networks, such as one or more gateways, switches, and/or routers, as well as one or more optical, coaxial, and/or hybrid fiber-coaxial lines, one or more satellite links, one or more radio links, and/or other systems and components. These systems and components may, for example, enable broadband network gateway 330 to provide telephone services and/or data/Internet access to one or more user devices at various locations.

As illustrated in FIG. 3, operating environment 300 also may include an example premises 350. In one or more arrangements, premises 350 may include a smart meter 360, a circuit breaker panel 365, one or more access points (e.g., an access point 370), and one or more wireless devices (e.g., wireless device 375). In some instances, operating environment 300 also may include one or more access points that are not located within premises 350, but instead are located nearby premises 350. Access point 380, as shown in FIG. 3, is an example of an access point that may be located outside of but close to, premises 350. As an example, access point 380 may be an access point that is located at a premises that is adjacent to premises 350 or otherwise within the vicinity of premises 350 (e.g., within the maximum range of wireless signals transmitted by an access point).

In some embodiments, smart meter 360 may be physically connected to one or more utility lines, such as one or more electrical power lines, water lines, and/or gas lines, and smart meter 360 may be configured to measure consumption of one or more resources provided via such utility lines. For instance, in the example illustrated in FIG. 3, smart meter 360 is physically connected to a power line, and may be configured to measure the amount of electrical power consumed at premises 350 from the power line. In addition, a smart meter may physically connect one or more utility lines to one or more distribution points at the premises. For instance, in the example illustrated in FIG. 3, smart meter 360 physically connects the power line to circuit breaker panel 365, which may operate as a distribution point for electrical power at premises 350.

In some embodiments, a smart meter also may observe wireless signals at the location at which the smart meter is installed. For example, smart meter 360 may observe wireless signals transmitted by base station 320 and/or base station 325 by detecting the presence of these signals and measuring various properties of these signals, which may include taking one or more received signal strength indication (RSSI) measurements, one or more time of arrival (TOA) measurements, one or more angle of arrival (AOA) measurements, and/or one or more round trip time (RTT) measurements. While these measurements are listed here as examples, other measurements may similarly be taken by smart meter 360 in addition to and/or instead of one or more of these measurements.

As another example, smart meter 360 may observe wireless signals transmitted by access point 370 by similarly detecting the presence of these signals and measuring various properties of the signals. For instance, access point 370 may be configured to provide a local wireless network at premises 350, and smart meter 360 may detect and observe signals transmitted by access point 370 in providing the local network.

In some embodiments, a smart meter may both actively observe wireless signals and passively observe wireless signals. In a passive mode, the smart meter may receive signals and may activate and/or otherwise use a cellular transceiver and/or a WiFi transceiver to listen for and measure wireless signals. On the other hand, in an active mode, the smart meter may send a probe message to a transmitter and wait for a response. This may, for instance, be used in observing WiFi signals, in which the smart meter may periodically send a probe request that causes all wireless access points detecting the probe request to respond. If RTT information is being gathered by the smart meter, then in observing both cellular and WiFi signals, the smart meter may send an active probe, wait for a response, and then measure the round trip time between sending the probe and receiving the response(s).

In addition to observing wireless signals that are transmitted by access point 370 and/or other devices that may be located at premises 350, smart meter 360 also may observe wireless signals that are transmitted by access points and/or other devices that are located outside of premises 350 and/or within the vicinity of premises 350. For example, smart meter 360 may observe wireless signals that are transmitted by access point 380, which may be located at another premises nearby premises 350, as discussed above.

In some embodiments, in addition to being configured to observe wireless signals (e.g., WLAN signals) transmitted by access points (e.g., WIN access points, wireless routers, femtocells, etc.) and/or wireless and/or cellular signals (e.g., GSM signals, CDMA signals, UMTS/WCDMA signals, LTE signals, TD-SCDMA signals, etc.) transmitted by base stations (e.g., base transceiver stations (BTSs), radio base stations (RBSs), etc.), smart meter 360 also may be configured to observe wireless signals transmitted by one or more other devices instead of and/or in addition to the access points and base stations discussed above. For example, smart meter 360 additionally or alternatively may be configured to observe broadcast and/or wireless broadband signals (e.g., DTV signals, MediaFLO signals, ISDB-T signals, DVB-H signals, etc.), GNSS signals (e.g., GPS signals, GLONASS signals, Galileo signals, COMPASS signals, QZSS signals, IRNSS signals, SBAS signals), WPAN signals (e.g., Zigbee signals, BT signals, UWB signals, NFC signals, RFID signals, etc.), and/or any other type(s) of signals. As discussed in greater detail below, in addition to observing various signals, smart meter 360 may gather and report information about any and/or all of the signals that are observed to one or more signals almanac servers.

In particular, in addition to observing wireless signals at premises 350, smart meter 360 also may report information about the observed signals to signal almanac server 305. As illustrated in FIG. 3, smart meter 360 may report this information using one or more network connections available to smart meter 360, such as one or more cellular data connections provided by base station 320 and/or base station 325, one or more wireless data connections provided by access point 370, and/or one or more wireline connections between smart meter 360 and signal almanac server 305. For example, smart meter 360 may report information about observed signals using a cellular connection and/or a WiFi connection in some instances, and in other instances, smart meter 360 may report information about observed signals using a broadband connection (e.g., using a broadband connection from smart meter 360 to signal almanac server 305 via broadband network gateway 330). In some embodiments, smart meter 360 may report this information by sending a signal observations message, which is discussed in greater detail below with respect to FIG. 4, to signal almanac server 305 of FIG. 3. Additionally, in some instances, an intermediate entity that is controlled by the utility company (e.g., the utility company that installed smart meter 360) may be provided as an intermediary between network 310 and signal almanac server 305 to transfer and/or otherwise provide the signal observations information and other data provided by one or more smart meters to signal almanac server 305.

By observing wireless signals at premises 350, smart meter 360 may collect information that can enable a mobile device located at or near premises 350 to determine its estimated position. For example, as illustrated in FIG. 3, a wireless device 375 may be located at premises 350. If, for instance, smart meter 360 has observed the wireless signals present at premises 350 (e.g., from base station 320, base station 325, and access point 370) and reported information about these signals back to signal almanac server 305, then when wireless device 375 is able to detect similar signals to those observed by smart meter 360, wireless device 375 may be able to determine that it is located at or near the location of smart meter 360. To make this determination, wireless device 375 may send information to signal almanac server 305 describing the signals that wireless device 375 has detected. Subsequently, signal almanac server 305 may analyze this information, for instance, by comparing the signals detected by wireless device 375 with information about observable signals at various locations. Signal almanac server 305 then may determine, based on the analysis of the signals detected by wireless device 375 and based on the signals observed at premises 350 by smart meter 360, that wireless device 375 is located at or near premises 350. In other arrangements, signal almanac server 305 may provide information about observable wireless signals to wireless device 375, so as to enable wireless device 375 to analyze and/or compare detected wireless signals with observed wireless signals, and thereby determine its position for itself.

In other embodiments, wireless device 375 may provide a coarse indication of its current position to location assistance server 308 in order to obtain regional almanac information that can be used by wireless device 375 to determine a more precise position fix. Such signal almanac information may, for instance, be stored by signal almanac server 305, which may be configured to aggregate, refine, and/or maintain signal almanac information, as discussed above. In addition, signal almanac server 308 may be further configured to communicate with anti/or otherwise provide such signal almanac information to location assistance server 308, so as to allow location assistance server 308 to assist various mobile devices in determining position.

For example, the coarse indication of position provided by wireless device 375 to location assistance server 308 may include a Cell ID (CID) which may uniquely identify a cellular base station (e.g., base station 320, base station 325, etc.) to which wireless device 375 is connected and/or within range of. Using the Cell ID provided by wireless device 375, location assistance server 308 may determine, based on the Cell ID, that wireless device 375 is within a particular region. Subsequently, location assistance server 308 may request signal almanac information for the region from signal almanac server 305. Based on the request received from location assistance server 308, signal almanac server 305 may look up, package, and provide refined regional signal almanac information for the particular region to location assistance server 308. Thereafter, location assistance server 308 may serve the refined regional signal almanac information to wireless device 375, which may then use the regional signal almanac information to determine its position based on the wireless signals that it can observe (e.g., based on the signals transmitted by base station 320, base station 325, access point 370, and/or access point 380, as observed by wireless device 375). As discussed above, in other instances, wireless device 375 may provide information describing the signals it has observed to location assistance server 308 which may then compute a position fix for wireless device 375 and provide the computed position to wireless device 375.

Because a smart meter, such as smart meter 360, is typically installed at a particular, fixed, and known location (e.g., premises 350) for a relatively long period of time, smart meters can be used to more reliably and accurately collect information about observed wireless signals at various locations than other devices that may conventionally be used in gathering information about observable wireless signals, which may have less accurate, less reliable location estimates. Moreover, because a great number of smart meters may be deployed at various locations throughout a large area, such as a village, town, city, or the like, a group of smart meters can be used to collectively observe signals at a number of locations throughout a particular area, thereby enhancing the resolution and utility of this crowd-sourced signal observation information for position determination purposes.

FIG. 4 illustrates an example of a signal observations message 400 according to some embodiments. In some embodiments, a signal observations message may be sent as one or more data messages from a smart meter to a signal almanac server in order to provide the signal almanac server with information about wireless signals observed by the smart meter at the location at which the smart meter is installed. For example, a smart meter (e.g., smart meter 360 shown in FIG. 3) may send signal observations message 400 to a signal almanac server (e.g., signal almanac server 305 shown in FIG. 3), as this may enable the signal almanac server to provide position assistance information to one or more mobile devices located in a vicinity of the smart meter (e.g., at or near the smart meter).

As seen in FIG. 4, signal observations message 400 may include one or more data fields in which various types of information may be stored. For example, signal observations message 400 may include a source information field 405, a location information field 410, and one or more signal information fields 415 and 460. While these fields are discussed here as examples, a signal observations message may, in other embodiments, include additional or alternative fields instead of and/or in addition to those listed above.

In some embodiments, source information field 405 may include information describing the source of signal observations message 400. For example, source information field 405 may include one or more unique identifiers assigned to and/or otherwise associated with the smart meter sending signal observations message 400. These unique identifiers may, for instance, include a serial number assigned to the smart meter and/or one or more account numbers corresponding to service usage measured by the smart meter (e.g., one or more account numbers to which one or more types of service usage measured by the smart meter are billed).

In some embodiments, location information field 410 may include information describing the location of the device sending signal observations message 400. For example, location information field 410 may include information specifying the location of the smart meter sending signal observations message 400. This information may, for instance, include a street address of the premises at which the smart meter is installed, geographic coordinates of the smart meter and/or the premises (e.g., latitude, longitude, altitude, etc.), and/or error information.

In one or more arrangements, the error information included in location information field 410 of signal observations message 400 may specify an error factor corresponding to an estimate of the amount of location error that may arise in using the location of the smart meter as an estimated position for a mobile device observing the same and/or similar wireless signals as the smart meter. For example, the error information may be indicative of the positional accuracy of the installation location of the smart meter. In at least one arrangement, the error factor may be based on the size of the premises at which the smart meter is installed. For instance, the larger the size of the premises at which the smart meter is installed, the greater the error factor in the location assistance message may be, since the area of the premises also may represent the area in which a mobile device observing the same and/or similar wireless signals can possibly be located.

In some instances, the manner in which location information is stored in location information field 410 may affect the degree of location error reflected in the error information included in location information field 410. For example, if location information describing the location of the smart meter is stored in location information field 410 as a street address, then the error factor specified by the error information may indeed scale in proportion to the size of the premises at which the smart meter is installed. On the other hand, if location information describing the location of the smart meter is stored in location information field 410 as a geodetic coordinate (e.g., latitude, longitude, altitude), then the error factor specified by the error information may reflect the accuracy of the location coordinate. In these cases, the accuracy of such a location coordinate may, for instance, depend on the manner in which the smart meter was installed at the premises. For example, the location coordinate may be quite accurate if, for instance, the position of the smart meter was determined using a GPS fix. On the other hand, the location coordinate may be less accurate if, for instance, it was determined using a less accurate technique (e.g., based on the street address and size of the premises at which the smart meter is installed).

In other instances, a signal observations message, such as signal observations message 400, might not include any location information or a location information field. Rather, a recipient of such a signal observations message may rely on a unique identifier corresponding to the smart meter, as may be stored in source information field 405, to determine the source of the signal observations message, and subsequently look up the location of the smart meter that sent the signal observations message, as well as error information associated with the smart meter.

In some embodiments, a signal information field, such as signal information field 415, may include information describing a particular signal observed by the device sending signal observations message 400. For example, for one example signal observed by a smart meter sending signal observations message 400, signal information field 415 may include a number of subfields specifying various properties of the signal. These sub-fields may include, for instance, a signal identifier information subfield 420, a signal type information subfield 425, a signal name information subfield 430, a received signal strength indication (RSSI) information subfield 435, a time-of-arrival (TOA) information subfield 440, an angle-of-arrival (AOA) information subfield 445, a round-trip-time (UT) information subfield 450, and an other information subfield 455. While these subfields are discussed here as examples, signal information field 415 may, in other embodiments, include additional or alternative fields instead of and/or in addition to those listed above. For example, in some other embodiments, signal information field 415 may additionally or alternatively include Doppler information associated with an observed wireless signal, as well as a corresponding subfield for storing such information. While a smart meter and the wireless transmitters that are being observed by the smart meter will, in many instances, be stationary, such that the Doppler measurements associated with observed signals will be 0 Hz, there may be some instances in which the smart meter observes signals transmitted by a mobile transmitter, such as a mobile WiFi access point (e.g., a WiFi device). In such an example, a smart meter observing a signal transmitted by a mobile transmitter may obtain Doppler measurements associated with the signal, and these measurements may be included in signal information field 415 of signal observations message 400 when reporting information about the observed signal.

In one or more arrangements, signal identifier information subfield 420 may include information specifying an identifier, such as an alphanumeric string of characters, associated with the observed wireless signal (e.g., the particular signal that is the subject of signal information 415 in signal observations message 400). Signal type information subfield 425 may include information specifying what type of signal the observed wireless signal is, such as an IS-9.5 cellular signal or an IEEE 802.11g WLAN signal, for instance. Signal name information subfield 430 may include information specifying a name associated with the observed wireless signal, such as an SSID of a WLAN signal, for example.

In one or more arrangements. RSSI information subfield 435 may include information representing an RSSI measurement of the observed wireless signal. Similarly, TOA information subfield 440. AOA information subfield 445, and RTT information subfield 450 may respectively include information representing a TOA measurement of the observed wireless signal, an AOA measurement of the observed wireless signal, and an RTT measurement of the observed wireless signal. Additionally or alternatively, other information subfield 455 may include information representing one or more other measurements associated with the observed wireless signal.

In some embodiments, signal observations message 400 may include information about two or more observed wireless signals. Thus, in these embodiments, signal observations message 400 may include one or more additional signal information fields, such as signal information field 460. These additional signal information fields (e.g., signal information field 460) may include one or more subfields 465 similar to those included in signal information field 415, as discussed above. Additionally or alternatively, a signal observations message, such as signal observations message 400, may include a plurality of observations of each of the various types of measurements that may be obtained by a smart meter in observing wireless signals, as well as any number of additional subfields as may be needed to store information about these observations. For example, a smart meter may observe signals transmitted by a first number of cellular base stations, as well as signals transmitted by a second number of wireless access points, and for each of the observed signals, the smart meter may collect one or more types of measurements (e.g., RSSI measurements, TOA measurements, AOA measurements, RTT measurements, etc.) and store the collected information in any number of subfields. In addition, any and/or all of the measurement information collected by the smart meter in observing wireless signals transmitted by various sources may, for instance, be included in a single signal observations message, such as signal observations message 400, or may be divided into any number of signal observations messages, as may be desired.

In some additional and/or alternative embodiments, signal observations message 400 may include additional information about other measurements obtained by the smart meter that relate to the operating environment of the smart meter. This additional information may, for instance, be used for a variety of purposes, including remotely validating the installation location of the smart meter. As an example, some additional measurements that may be obtained by a smart meter include measurements of ambient light levels, captured audio signatures, captured camera images, and/or other sensory data that may, for instance, be used in classifying an environment in which the smart meter is operating.

FIG. 5 illustrates an example method of providing information about observed wireless signals to a signal almanac server according to some embodiments. The processing illustrated in FIG. 5 may be implemented in software (e.g., computer-readable instructions, code, programs, etc.) that can be executed by one or more processors and/or other hardware components. Additionally or alternatively, the software may be stored on a non-transitory computer-readable storage medium.

As seen in FIG. 5, the method may be initiated in step 505, in which configuration information may be received. In some embodiments, configuration information may be received by system 100 of FIG. 1, for example, which may be incorporated into a smart meter. In addition, the configuration information may be received via input/output subsystem 105 of system 100 and/or may include information identifying a current location of system 100. For example, the configuration information may include a street address at which system 100 is installed and/or geographic coordinates of the location at which system 100 is installed. Further, the configuration information may include any and/or all of the information that can be included in a source information field or a location information field of a signal observations message, such as the information that can be included in source information field 405 and location information field 410 of signal observations message 100, as discussed above with respect to FIG. 4. For instance, the configuration information received in step 505 may include one or more account numbers with respect to which system 100 may be configured to report service usage, a device identifier assigned to system 100, and/or error information associated with the size of the premises at which system 100 may be installed. As noted above, system 100 may store any and/or all of this configuration information in one or more subsystems of system 100, such as location management subsystem 115.

In step 510, service usage may be measured. For example, system 100 may measure service usage using metering subsystem 110. This may include, for instance, measuring an amount of electric power consumed at the premises at which system 100 is installed, measuring an amount of water consumed at the premises at which system 100 is installed, and/or measuring an amount of gas consumed at the premises at which system 100 is installed. In addition to measuring this service usage information, metering subsystem 110 of system 100 also may store such measurements to facilitate reporting the usage to the appropriate utility company (or companies) for billing purposes, for instance.

Subsequently, in step 515, the measured service usage may be reported. For example, system 100 may report the service usage measured in step 510 to one or more utility companies that provide the services consumed at the premises. To report the service usage, system 100 may, for instance, use communications subsystem 120 to send information describing the service usage to one or more server computers operated by one or more utility companies. In sending this information, communications subsystem 120 of system 100 may connect to and/or communicate via an access point located at the premises at which system 100 is installed (e.g., access point 370 at premises 370 shown in FIG. 3). Additionally or alternatively, in sending this information, communications subsystem 120 of system 100 may connect to and/or communicate via a base station of an available cellular network (e.g., base station 320 or base station 325 shown in FIG. 3).

In step 520, one or more wireless signals may be observed. For example, system 100 may observe one or more wireless signals using signal observation subsystem 125 of communications subsystem 120. As discussed above, in observing one or more wireless signals, signal observation subsystem 125 may, for instance, enable one or more wireless interfaces provided by communications subsystem 120, scan for and receive one or more wireless signals that are capable of being received at the current location of system 100 (and the smart meter into which system 100 may be incorporated), and record and store information describing various properties of the received wireless signals, as well as any other information that may be desirable, such as the time and/or date at which the signals were received. In some embodiments, the information measured, recorded, and/or stored by signal observation subsystem 125 of system 100 in observing one or more wireless signals may include any and/or all of the information that can be included in a signal information field of a signal observations message, such as the information that can be included in signal information field 415 of signal observations message 400, as well as its associated subfields, as discussed above with respect to FIG. 4.

Subsequently, in step 525, information about the one or more observed wireless signals may be reported to a signal almanac server. For example, system 100 may report information about the one or more observed wireless signals to a signal almanac server using observation reporting subsystem 130 of communications subsystem 120. As discussed above, in reporting information about observed wireless signals to a signal almanac server, observation reporting subsystem 130 may, for instance, establish a data connection with the signal almanac server and subsequently send one or more data messages to the signal almanac server. In some embodiments, one or more of these messages sent by observation reporting subsystem 130 may be signal observations messages, such as signal observations message 400, as discussed above with respect to FIG. 4.

In some sore embodiments, the method then may return to step 510, and system 100 may continue to measure service usage information. In these embodiments, system 100 may repeat execution of steps 510, 515, 520, and/or 525. This may, for instance, include periodically retransmitting one or more signal observations messages. In other embodiments, the method may return to step 520, and system 100 may again observe one or more wireless signals. In these embodiments, system 100 may repeat execution of steps 520 and/or 525. This likewise may include transmitting one or more additional signal observations messages. In some instances, a smart meter and/or system 100 may be configured to periodically observe signals (e.g., by periodically repeating execution of steps 520 and 525), as some signal observables may change depending on the time of day (e.g., cellular network loading and/or usage), while other transmitters may be moved or replaced (e.g., an access point located in a residential home).

As discussed above, a smart meter may, in some embodiments, provide information about observed wireless signals to a signal almanac server, which may enable the signal almanac server and/or a location assistance server to provide position assistance to one or more other devices that may be located at or near the smart meter. An overview of the processing that may be performed by such a signal almanac server (e.g., signal almanac server 305) and/or a location assistance server (e.g., location assistance server 308) will now be discussed in greater detail with reference to FIGS. 6A, 6B, and 6C.

In particular, FIG. 6A illustrates an example method of receiving and maintaining information about observed wireless signals according to some embodiments. As seen in FIG. 6A, the method may be initiated in step 605, in which a signal almanac server, such as signal almanac server 305, may receive information about one or more observed wireless signals. For example, in step 605, the signal almanac server may receive a signal observations message, such as signal observations message 400, as discussed above with respect to FIG. 4, from a smart meter. While the examples discussed here involve a signal almanac server receiving information about one or more observed wireless signals from a smart meter, the signal almanac server may likewise receive similar information from one or more other devices that might not be smart meters, such as other fixed devices that are capable of and/or configured to observe and report wireless signals, as well as mobile devices that are capable of and/or configured to observe and report wireless signals.

In step 610, the signal almanac server may determine a reliability ranking for the signal observation information received in step 605. For example, in step 610, the signal almanac server 305 may determine a reliability ranking for the signal observation information received in step 605, based on the source of the signal observation information. As discussed above, in instances where the signal observation information is received as a signal observations message, such as signal observations message 400, the signal observations message may include one or more subfields that include information specifying the source of the signal observations message.

In some embodiments, signal almanac server may, for instance, be configured to assign a higher reliability ranking to signal observation information that is received from a smart meter, and may be further configured to assign a lower reliability ranking to signal observation information that is received from another source, such as a mobile device. In some instances, reliability rankings may be assigned to signal observation information in this way, as smart meters may be considered to be more reliable sources of signal observation information than mobile devices and/or other sources of signal observation information. Accordingly, signal observation information that is received from a smart meter may be considered to be more reliable and can therefore be assigned a higher reliability ranking.

In step 615, the signal almanac server may aggregate, refine, and/or filter the received signal observation information. For example, in step 615, signal almanac server 305 may combine the received signal observation information with other signal observation information stored in a signal almanac database maintained by signal almanac server 305. In addition, signal almanac server 305 may refine and/or filter the received signal observation information (e.g., by removing and/or otherwise filtering out data points that are considered to be outliers, by executing one or more refinement and/or filter algorithms, by otherwise processing the received signal information, etc.).

In step 620, the signal almanac server may update the signal almanac database in view of the received signal information. For example, in step 620, signal almanac server 305 may store the aggregated, refined, and/or filtered signal observation information in the signal almanac database, such that the signal observation information may be used in the future in assisting other devices in determining their position.

As discussed in greater detail below, there are several ways in which the signal observation information may be used in assisting a mobile device in determining its position. Two examples of how signal observation information may be used in determining position will now be discussed in greater detail with respect to FIGS. 6B and 6C.

FIG. 6B illustrates an example method of providing calculation assistance to a mobile device in an MS-Assisted mode of operation according to some embodiments. As illustrated in the discussion below, in an MS-Assisted mode of operation, a mobile device may provide information about the wireless signal(s) that it can observe to a location server, which may then compute the position of the mobile device based on the signal observations, and subsequently return the computed position to the mobile device for use by the mobile device in various applications.

In step 625, a mobile device may provide information describing currently observed wireless signals to a location server. For example, in step 625, wireless device 375 may provide information about the signals that it can currently observe to location server 308.

In step 630, the location server may load signal almanac information from a signal almanac server. For example, in step 630, location assistance server 308 may load signal almanac information from signal almanac server 305. In some embodiments, location assistance server 308 may be configured to request regional signal almanac information from signal almanac server 305 based on a coarse understanding of the current position of wireless device 375 (or whichever mobile device the location assistance server is assisting in position determination). Such a coarse understanding of position may, for instance, be determined and/or otherwise obtained based on transmitter information associated with the signals observed by the mobile device (e.g., one or more unique identifiers associated with any and/or all of the transmitters transmitting the observed wireless signals).

In step 635, the location server may compute the position of the mobile device. For example, in step 635, location server 308 may compute the position of wireless device 375, based on the almanac information received from signal almanac server 305 and further based on the one or more wireless signals observed by the mobile device (e.g., as reflected by the signal observation information provided to the location assistance server in step 625).

In step 640, the location server may provide the computed position to the mobile device. For example, in step 640, location server 308 may send one or more data messages to wireless device 375 that indicate and/or otherwise inform wireless device 375 of its current position.

In step 645, the mobile device may receive the computed position from the location server. For example, in step 645, wireless device 375 may receive the one or more data messages sent by location server 308, and subsequently may use the computed position in various applications being executed on and/or otherwise provided by wireless device 375.

FIG. 6C illustrates an example method of providing position assistance information to a mobile device in an MS-Based mode of operation according to some embodiments. As illustrated in the discussion below, in an MS-Based mode of operation, a mobile device may provide information about the wireless signal(s) that it can observe to a location server and/or a coarse indication of its current position to the location server, which may then look up and provide regional signal almanac information to the mobile device, thereby enabling the mobile device to compute its current position for itself.

In step 650, a mobile device may provide a coarse indication of its current position to a location server. Such a coarse indication of position may, for instance, include one or more Cell IDs that uniquely identify one or more transmitters transmitting wireless signals being observed by the mobile device. For example, in step 650, wireless device 375 may provide a coarse indication of its current position to location server 308. The coarse indication of position provided by wireless device 375 to location server 308 may, for instance, include one or more Cell IDs corresponding to one or more of base station 320 and base station 325, as this may be enable location server 308 to identify a particular region in which wireless device 375 is currently located.

In step 655, the location server may load signal almanac information from a signal almanac server. In particular, the location server may load regional signal almanac information from the signal almanac server based on the coarse indication of position provided by the mobile device. For example, in step 655, location server 308 may communicate with signal almanac server 305 in order to load regional signal almanac information corresponding to the region in which the mobile device is currently located (e.g., as identified by the location server based on the Cell ID or other coarse indication of position provided in step 650). As discussed above, the regional signal almanac information may, for instance, specify various properties of wireless signals that can be observed in the particular region to which the regional signal almanac information corresponds.

In step 660, the location server may provide the regional signal almanac information to the mobile device. For example, in step 660, location server 308 may provide the regional signal almanac information obtained from signal almanac server 305 to wireless device 375. Such signal almanac information may be sent by location server 308 to wireless device 375 via one or more data messages, for instance.

In step 665, the mobile device may compute its current position based on the regional signal almanac information obtained from the location server and based on the one or more wireless signals that the mobile device can currently observe. For example, in step 665, wireless device 375 may compute its current position based on the regional signal almanac information received from location server 308 and based on the properties of the various signals that wireless device 375 can observe at its current position.

Having described several modes of operation in which signal almanac information can be used in providing position assistance functionalities, several examples illustrating how a device can determine a position based on signal almanac information and information about observed wireless signals will now be discussed.

In some embodiments, for instance, a technique known as “RF Fingerprinting” may be used to determine a location of a device based on signal almanac information and information about observed wireless signals. In RE Fingerprinting, a grid of possible locations may be established and an RE signature or fingerprint at each grid point may be defined. The signature may, for instance, include RSSI data for each transmitter observed, or may include both RSSI data and WIT information for each transmitter observed. Thereafter, the location of the mobile device may be calculated by finding the grid point which has a signature that most closely matches the signals observed by the mobile device. This calculation may, for instance, be performed both in an MS-Assisted mode of operation and in an MS-Based mode of operation, as the mobile device may report its observations and a location server may perform the matching involved in RF Finger printing (e.g., in an MS-Assisted mode of operation), or the server may provide a regional fingerprint database to the mobile device, and the mobile device may perform the matching on its own (e.g., in an MS-Based mode of operation).

In some embodiments, another technique known as “Calculated Location” may be used to determine a position of a device based on signal almanac information and information about observed wireless signals. In the Calculated Location technique, an aggregation server may attempt to reverse position the wireless transmitters observed by a mobile device based on the locations and signal observations reported by the various smart meters, mobile devices, and other devices observing wireless signals at various locations. Once the transmitter positions are determined, a location may be calculated using various estimation techniques (e.g., by solving ranging equations using RTT and/or TOA information, by calculating a weighted centroid position of transmitters using RSSI to weight transmitter locations, etc.). The particulars of both of these techniques will be readily apparent to one of ordinary skill in the art.

According to one or more aspects, a computer system as illustrated in FIG. 7 may be incorporated as part of a computing device, which may implement, perform, and/or execute any and/or all of the features, methods, and/or method steps described herein. For example, computer system 700 may represent some of the components of a smart meter, an access point, a signal almanac server, or any other computing device, such as a laptop computer, a tablet computer, a smart phone, a video-game console, or a desktop computer. In addition, computer system 700 may represent some of the components of system 100 of FIG. 1. FIG. 7 provides a schematic illustration of one embodiment of a computer system 700 that can perform the methods provided by various other embodiments, as described herein. FIG. 7 is meant only to provide a generalized illustration of various components, any and/or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, a mouse, a keyboard and/or the like; and one or more output devices 720, which can include without limitation a display unit, a printer and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 730, which can include without limitation a modern, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 5 and 6, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein, for example one or more steps of the methods described with respect to FIGS. 5 and 6.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect, to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, in some embodiments, a device other than a smart meter may include and/or otherwise provide one or more of the components and/or functionalities discussed above, and accordingly may implement one or more embodiments described herein. For instance, passive utility devices and/or other devices that, like a smart meter, may be installed at a substantially fixed location for a significant period of time, may, in some embodiments, be configured to observe wireless signals and/or provide signal observation information to one or more signal almanac servers, in accordance with various aspects of the disclosure. One example of another device that may provide and/or otherwise implement various embodiments and/or other arrangements discussed above is a smart mailbox, which like a smart meter, may, for instance, be installed at a relatively fixed location (e.g., outside a home or building), be associated with some known indicia of position (e.g., a street address of the home or building), and/or may include transceiver circuitry and/or other components (e.g., which may enable the smart mailbox to observe wireless signals and report signal observation information back to a signal almanac server). While a smart mailbox is listed here as an example of another type of device, other than a smart meter, that may provide and/or otherwise implement one or more of the embodiments discussed above, other devices may likewise provide and/or otherwise implement such embodiments instead of and/or in addition to a smart mailbox. For example, various home appliances, such as refrigerators, ovens, air conditioning units, and so on, may likewise be configured to provide and/or otherwise implement one or more of the embodiments discussed above.

In still additional and/or alternative embodiments, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method, comprising:
Observing, by a smart meter installed at a location, one or more wireless signals at the location; and
providing, by the smart meter, to at least one signal almanac server, information that identifies the location and describes one or more detected properties of the one or more observed wireless signals.

2. The method of claim 1, wherein the information provided to the at least one signal almanac server is configured to be used by the at least one signal almanac server in providing position assistance information to one or more mobile devices located in a vicinity of the location.

3. The method of claim 1, wherein the smart meter is configured to measure consumption of one or more resources.

4. The method of claim 3, wherein at least one resource of the one or more resources is electric power.

5. The method of claim 3, wherein at least one resource of the one or more resources is gas.

6. The method of claim 3, wherein at least one resource of the one or more resources is water.

7. The method of claim 1, wherein the information that identifies the location and describes the one or more detected properties of the one or more observed wireless signals includes at least one of:
one or more received signal strength indication (RSSI) measurements corresponding to the one or more observed wireless signals;
one or more time of arrival (TOA) measurements corresponding to the one or more observed wireless signals;
one or more angle of arrival (AOA) measurements corresponding to the one or more observed wireless signals;
one or more round trip time (RTT) measurements corresponding to the one or more observed wireless signals; and
one or more Doppler measurements corresponding to the of one or more observed wireless signals.

8. The method of claim 1, wherein the information that identifies the location and describes the one or more detected properties of the one or more observed wireless signals includes at least one of a street address, a service account number, a device identifier, and geographic coordinates.

9. The method of claim 8, wherein the information that identifies the location and describes the one or more detected properties of the one or more observed wireless signals includes error information associated with the location.

10. The method of claim 1,
wherein the smart meter is operated by a first entity providing at least one resource to a premises located at the location, and
wherein the at least one signal almanac server is operated by a second entity different from the first entity.

11. The method of claim 10, wherein the information that identifies the location and describes the one or more detected properties of the one or more observed wireless signals is provided to the at least one signal almanac server via an intermediate entity that is configured to communicate with a plurality of smart meters.

12. The method of claim 1, further comprising:
prior to observing the one or more wireless signals, receiving, by the smart meter, location information specifying the location at which the smart meter is installed.

13. The method of claim 1, wherein the one or more wireless signals include cellular signals.

14. The method of claim 13, wherein the cellular signals include GSM signals.

15. The method of claim 13, wherein the cellular signals include CDMA signals.

16. The method of claim 13, wherein the cellular signals include UMTS/WCDMA signals.

17. The method of claim 13, wherein the cellular signals include LTE signals.

18. The method of claim 13, wherein the cellular signals include TD-SCDMA signals.

19. The method of claim 1, wherein the one or more wireless signals include WLAN signals.

20. A smart meter comprising:
one or more processors; and
memory storing computer-readable instructions that, when executed by the one or more processors, cause the smart meter to:
observe one or more wireless signals at, a location at which the smart meter is installed; and
provide to at least one signal almanac server, information that identifies the location and describes one or more detected properties of the one or more observed wireless signals.

21. The smart meter of claim 20, wherein the information provided to the at least one signal almanac server is configured to be used by the at least one signal almanac server in providing position assistance information to one or more mobile devices located in a vicinity of the location.

22. The smart meter of claim 20, wherein the smart meter is configured to measure consumption of one or more resources.

23. The smart meter of claim 22, wherein at least one resource of the one or more resources is electric power.

24. The smart meter of claim 22, wherein at least one resource of the one or more resources is gas.

25. The smart meter of claim 22, wherein at least one resource of the one or more resources is water.

26. The smart meter of claim 20, wherein the information that identifies the location and describes the one or more detected properties of the one or more observed wireless signals includes at least one of:
one or more received signal strength indication (RSSI) measurements corresponding to the one or more observed wireless signals;
one or more time of arrival (TOA) measurements corresponding to the one or more observed wireless signals;
one or more angle of arrival (AOA) measurements corresponding to the one or more observed wireless signals;
one or more round trip time (RTT) measurements corresponding to the one or more observed wireless signals; and
one or more Doppler measurements corresponding to the one or more observed wireless signals.

27. The smart meter of claim 20, wherein the information that identifies the location and describes the one or more detected properties of the one or more observed wireless signals includes at least one of a street address, a service account number, a device identifier, and geographic coordinates.

28. The smart meter of claim 27, wherein the information that identifies the location and describes the one or more detected properties of the one or more observed wireless signals includes error information associated with the location.

29. The smart meter of claim 20,
wherein the smart meter is operated by a first entity providing at least one resource to a premises located at the location, and
wherein the at least one signal almanac server is operated by a second entity different from the first entity.

30. The smart meter of claim 29, wherein the information that identifies the location and describes the one or more detected properties of the one or more observed wireless signals is provided to the at least one signal almanac server via an intermediate entity that is configured to communicate with a plurality of smart meters.

31. The smart meter of claim 20, wherein the memory stores additional computer-readable instructions that, when executed by the one or more processors, further cause the smart meter to:
receive location information specifying the location at which the smart meter is installed, prior to observing the one or more wireless signals.

32. The smart meter of claim 20, wherein the one or more wireless signals include cellular signals.

33. The smart meter of claim 32, wherein the cellular signals include GSM signals.

34. The smart meter of claim 32, wherein the cellular signals include CDMA signals.

35. The smart meter of claim 32, wherein the cellular signals include UMTS/WCDMA signals.

36. The smart meter of claim 32, wherein the cellular signals include LTE signals.

37. The smart meter of claim 32, wherein the cellular signals include TD-SCDMA signals.

38. The smart meter of claim 20, wherein the one or more wireless signals include WLAN signals.

39. One or more computer-readable media storing computer-executable instructions that, when executed, cause one or more computing devices included in a smart meter to:
observe one or more wireless signals at a location at which the smart meter is installed; and
provide to at least one signal almanac server, information that identifies the location and describes one or more detected properties of the one or more observed wireless signals.

40. The one or more computer-readable media of claim 39, wherein the information provided to the at least one signal almanac server is configured to be used by the at least one signal almanac server in providing position assistance information to one or more mobile devices located in a vicinity of the location.

41. The one or more computer-readable media of claim 39, wherein the smart meter is configured to measure consumption of one or more resources.

42. The one or more computer-readable media of claim 41, wherein at least one resource of the one or more resources is electric power.

43. The one or more computer-readable media of claim 41, wherein at least one resource of the one or more resources is gas.

44. The one or more computer-readable media of claim 41, wherein at least one resource of the one or more resources is water.

45. The one or more computer-readable media of claim 39, wherein the information that identifies the location and describes the one or more detected properties of the one or more observed wireless signals includes at least one of:
one or more received signal strength indication (RSSI) measurements corresponding to the one or more observed wireless signals;
one or more time of arrival (TOA) measurements corresponding to the one or more observed wireless signals;
one or more angle of arrival (AOA) measurements corresponding to the one or more observed wireless signals;
one or more round trip time (RTT) measurements corresponding to the one or more observed wireless signals; and
one or more Doppler measurements corresponding to the one or more observed wireless signals.

46. The one or more computer-readable media of claim 39, wherein the information that identifies the location and describes the one or more detected properties of the one or more observed wireless signals includes at least one of a street address, a service account number, a device identifier, and geographic coordinates.

47. The one or more computer-readable media of claim 46, wherein the information that identifies the location and describes the one or more detected properties of the one or more observed wireless signals includes error information associated with the location.

48. The one or more computer-readable media of claim 39,
wherein the smart meter is operated by a first entity providing at east one resource to a premises located at the location, and
wherein the at least one signal almanac server is operated by a second entity different from the first entity.

49. The one or more computer-readable media of claim 48, wherein the information that identifies the location and describes the one or more detected properties of the one or more observed wireless signals is provided to the at least one signal almanac server via an intermediate entity that is configured to communicate with a plurality of smart meters.

50. The one or more computer-readable media of claim 39, having additional computer-executable instructions stored thereon that, when executed, further cause the one or more computing devices included in the smart meter to:
receive location information specifying the location at which the smart meter is installed, prior to observing the one or more wireless signals.

51. The one or more computer-readable media of claim 39, wherein the one or more wireless signals include cellular signals.

52. The one or more computer-readable media of claim 51, wherein the cellular signals include GSM signals.

53. The one or more computer-readable media of claim 51, wherein the cellular signals include CDMA signals.

54. The one or more computer-readable media of claim 51, wherein the cellular signals include UMTS/WCDMA signals.

55. The one or more computer-readable media of claim 51, wherein the cellular signals include LTE signals.

56. The one or more computer-readable media of claim 51, wherein the cellular signals include TD-SCDMA signals.

57. The one or more computer-readable media of claim 39, wherein the one or more wireless signals include WLAN signals.

58. A smart meter apparatus comprising:
means for observing one or more wireless signals at a location at which the smart meter apparatus is installed; and
means for providing, to at least one signal almanac server, information that identifies the location and describes one or more detected properties of the one or more observed wireless signals.

59. The smart meter apparatus of claim 58, wherein the information provided to the at least one signal almanac server is configured to be used by the at least one signal almanac server in providing position assistance information to one or more mobile devices located in a vicinity of the location.

60. The smart meter apparatus of claim 58, wherein the smart meter apparatus is configured to measure consumption of one or more resources.

61. The smart meter apparatus of claim 60, wherein at least one resource of the one or more resources is electric power.

62. The smart meter apparatus of claim 60, wherein at least one resource of the one or more resources is gas.

63. The smart meter apparatus of claim 60, wherein at east one resource of the one or more resources is water.

64. The smart meter apparatus of claim 58, wherein the information that identifies the location and describes the one or more detected properties of the one or more observed wireless signals includes at least one of:
one or more received signal strength indication (RSSI) measurements corresponding to the one or more observed wireless signals;
one or more time of arrival (TOA) measurements corresponding to the one or more observed wireless signals;
one or more angle of arrival (AOA) measurements corresponding to the one or more observed wireless signals;
one or more round trip time (RTT) measurements corresponding to the one or more observed wireless signals; and
one or more Doppler measurements corresponding to the one or more observed wireless signals.

65. The smart meter apparatus of claim 58, wherein the information that identifies the location and describes the one or more detected properties of the one or more observed wireless signals includes at least one of a street address, a service account number, a device identifier, and geographic coordinates.

66. The smart meter apparatus of claim 65, wherein the information that identifies the location and describes the one or more detected properties of the one or more observed wireless signals includes error information associated with the location.

67. The smart meter apparatus of claim 58,
wherein the smart meter apparatus is operated by a first entity providing at least one resource to a premises located at the location, and
wherein the at least one signal almanac server is operated by a second entity different from the first entity.

68. The smart meter apparatus of claim 67, wherein the information that identifies the location and describes the one or more detected properties of the one or more observed wireless signals is provided to the at least one signal almanac server via an intermediate entity that is configured to communicate with a plurality of smart meters.

69. The smart meter apparatus of claim 58, further comprising:
means for receiving location information specifying the location at which the smart meter apparatus is installed.

70. The smart meter apparatus of claim 58, wherein the one or more wireless signals include cellular signals.

71. The smart meter apparatus of claim 70, wherein the cellular signals include GSM signals.

72. The smart meter apparatus of claim 70, wherein the cellular signals include CDMA signals.

73. The smart meter apparatus of claim 70, wherein the cellular signals include UMTS/WCDMA signals.

74. The smart meter apparatus of claim 70, wherein the cellular signals include LTE signals.

75. The smart meter apparatus of claim 70, wherein the cellular signals include TD-SCDMA signals.

76. The smart meter apparatus of claim 70, wherein the one or more wireless signals include WLAN signals.

77. A server comprising:
at least one processor; and
memory storing computer-readable instructions that, when executed, cause the server to:
receive, from a smart meter installed at a first location, information describing one or more wireless signals observed by the smart meter at the first location; and
update a signal almanac database based on the received information.

78. The server of claim 77, wherein the memory stores additional computer-readable instructions that, when executed, cause the server to:
provide position assistance functionalities to one or more mobile devices using information included in the signal almanac database.

79. The server of claim 77, wherein the signal almanac database includes signal observation information provided by a plurality of smart meters installed at a plurality of different locations.

80. The server of claim 79, wherein the signal almanac database further includes signal observation information provided by one or more mobile devices.
